(19) United States
(12) Patent Application Publication
(10) Pub. No.: US 2007/0063028 A1
(43) Pub. Date: Mar. 22, 2007

(54) Integrated processing system for point-of-sale station and methods therefor

(75) Inventor: Douglas Byerley, Overland Park, KS (US)

Correspondence Address: TOWNSEND AND TOWNSEND AND CREW, LLP, TWO EMBARCADERO CENTER, EIGHTH FLOOR, SAN FRANCISCO, CA, 94111-3834, US

(73) Assignee: First Data Corporation, Englewood, CO (US)

(21) Appl. No.: 11/231,361

(22) Filed: Sep. 19, 2005

(51) Int. Cl. G06K 15/00; G07F 19/00; G06K 7/10

(52) U.S. Cl. 235/383; 235/379; 235/454

(57) ABSTRACT

The present invention includes systems and methods to conduct and process transactions between a merchant and a customer. In accordance with the present invention, when new, value-added functionalities are desired for existing legacy point-of-sale (POS) stations, specially adapted external device(s) of the invention may be communicatively coupled to existing legacy POS stations to incorporate the desired functionalities, without the need for expensive reprogramming or retrofitting of the legacy systems. By way of example, the desired functionalities may involve a variety of transaction programs such as electronic check conversion (ECC), Check 21, rewards programs, discount programs, loyalty programs, etc.

### BACKGROUND OF THE INVENTION

A modern point-of-sale (POS) station in a retail store has become a complex collection of legacy devices and systems. The conventional cash register has been augmented by a computer system programmed to receive and process data collected in a modern point-of-sale transaction. For example, the computer system is adapted to receive data from a bar code reader, radio frequency identification (RFID) chip reader, etc., about an item being purchased, as well as other data from a payment instrument reader (e.g., credit/debit card reader) and loyalty card information. The computer system also has to communicate with many different external transaction systems (e.g., credit card processing systems, debit card processing systems, check processing systems, etc.).

The increasing popularity of rewards programs, as well as the implementation of electronic check processing (e.g., Check 21 or electronic check conversion such as Electronic Check Acceptance™), are putting pressure on merchants to upgrade their POS stations, to comply with such programs. The Check Clearing for the 21st Century Act (“Check 21∞) went into effect on Oct. 28, 2004. Check 21 authorized the use of the Image Replacement Document (IRD), also known as the “substitute check”, in the check clearing process.

A merchant wishing to participate fully in these programs should have a POS station capable of many additional functionalities, such as image capture, processing on different transaction processing networks, etc. Unfortunately, incorporating all the additional functionality into existing POS systems is difficult and expensive. In many systems, hardware as well as software has to be replaced for the system to be fully operational for such programs. For merchants with large numbers of point-of-sale stations, regularly upgrading or replacing the stations can be prohibitively expensive.

Thus, there is a need for methods and systems that can give a POS station the capability to adapt to new programs, without having to perform extensive software and hardware upgrades on the current equipment.

### BRIEF SUMMARY OF THE INVENTION

The present invention addresses this and other needs, wherein systems and methods are provided for conducting and processing transactions between, e.g., a merchant and a customer.

In a first aspect, a system for processing at least one image or data file related to a transaction between a merchant and a customer is provided. The system generally comprises: a point-of-sale transaction terminal; an image or data file capture device adapted to capture an image or data file related to the transaction between the merchant and the customer; and a transaction file processing device in communication with at least one transaction file storage database via a communication network. The transaction file processing device is in communication with the image or data file capture device, and is configured to receive the image or data file from the image or data file capture device and to communicate the image or data file to the at least one transaction file storage database via the communication network. In accordance one embodiment of the present invention, the transaction file processing device is independently located from the point-of-sale transaction terminal and the image or data file capture device.

In another aspect of the invention, a method for processing at least one image or data file associated with a transaction between a first party, e.g., a merchant and a second party, e.g., a customer, is provided. The transaction may involve the exchange of payment, data, information, value, etc. The method generally comprises: providing a transaction file processing device in communication with at least one transaction file storage database via a communication network; initiating a transaction between a first party, e.g., a merchant, and a second party, e.g., a customer, at a point-of-sale transaction terminal located at, e.g., a merchant location; receiving an image or data file related to said transaction between, e.g., the merchant and the customer at the transaction file processing device from an image or data file capture device; and using said transaction file processing device to communicate said image or data file to said at least one transaction file storage database via said communication network. Again, in one embodiment of the invention, the transaction file processing device is independently located from the point-of-sale transaction terminal and the image or data file capture device.

In yet another aspect of the invention, a method for adding transactional processing capabilities to an existing point-of-sale transaction station, e.g., at a merchant location is provided. In general, such a method comprises: providing an image or data file capture device adapted to capture at least one image or data file associated with a transaction between said merchant and a customer; and providing a transaction file processing device in communication with at least one transaction file storage database via a communication network. In accordance with the method of the invention, the transaction file processing device is adapted to receive an image or data file from the image or data file capture device and to communicate the image or data file to the at least one transaction file storage database via said communication network without the need to reconfigure said existing point-of-sale transaction station. In certain embodiments, the transaction file processing device is communicatively coupled to and independently located from said existing point-of-sale transaction station and said image or data file capture device.

These and other aspects of the invention will become apparent to those skilled in the art with reference to the detailed description and drawings.

### BRIEF DESCRIPTION OF THE DRAWINGS

FIG. 1 illustrates and exemplary system in accordance with an embodiment of the invention.

FIG. 2 illustrates a process flow diagram of an exemplary method for processing an image and/or data file in accordance with an embodiment of the invention (optional steps shown in dashed lines).

FIG. 3 illustrates a process flow diagram for an exemplary transaction file processing device mode of operation in accordance with an embodiment of the invention (optional steps shown in dashed lines).

### DETAILED DESCRIPTION OF THE INVENTION

The present invention includes systems and methods to conduct and process transactions between a first party, e.g., a merchant and a second party, e.g., a customer. In accordance with the present invention, when new value-added functionalities are desired for existing legacy point-of-sale (POS) stations, external device(s) may be communicatively coupled to the existing POS stations to incorporate the desired functionalities. By way of example, the desired functionalities may involve a variety of transaction programs such as electronic check conversion (ECC), Check 21, rewards programs, discount programs, loyalty programs, etc.

In accordance with certain aspects of the invention, systems are provided which may combine a legacy or traditional POS station with, e.g., an optional image or data file capture device (if not already present as part of the POS station) and a transaction file processing device. The add-on device(s) allow the legacy system to participate in value-add transactional programs without significant reconfiguration of the POS station. The add-on device(s) may allow the legacy system to capture the needed image and/or data files, process the transaction data files, and communicate with one or more transaction processing networks that the system otherwise could not access without significant software and/or hardware changes. The add-on device(s) may also be used to enable the legacy system to conduct and settle transactions between a customer and merchant over transaction networks.

In certain embodiments, the image or data file capture device may already exist as part of the legacy POS station. For instance, the image or data file capture device may be part of an existing POS transaction terminal used to read check MICR information, credit card account information, debit card account information, stored value card information, reward program card information, loyalty program card information, etc. As such, the image or data file capture device may be used to capture image and/or data file information relating to transactions, such as MICR information, driver's license information, credit/debit/stored-value card transaction information, reward/loyalty program transaction information, etc.

Alternatively, the image or data file capture device may need to be added to the legacy system. For example, to implement Check 21 programs or other programs where image files are desirable, the legacy system will require imaging capabilities. If the legacy system does not already include a device capable of capturing images, an image or data file capture device will be provided. In such embodiments, the image or data capture device may be an image scanner capable of generating an image in any appropriate image format, such as a raster image format, a meta/vector image format, a graphic interchange format (“GIF”), or a joint photographic experts group (“JPEG”) format, among others. In such embodiments, the image or data file capture device may capture image file information relating to transactions, such as check images, driver's license images, credit card transaction sales slip images, debit card transaction sales slip images, stored-value card transaction sales slip images, reward program receipt images, loyalty program receipt images, etc.

The image or data capture device may be an external piece of equipment positioned at a location that provides convenient access for imaging processes. The image or data capture device may be designed such that almost no changes need to be made to the legacy system to make it compatible with the additional programs of interest. For example, in one embodiment, the device may optionally be plugged into an existing connector on the legacy system to enable operations. In another embodiment, the device communicates wirelessly with the legacy system. This may occur, for example, using a wireless port or device contained in or coupled to the device and/or to the legacy system. Alternatively, the image or data capture device may be communicatively coupled to the transaction file processing device of the invention via a communication port or wireless port. In such an embodiment, the image or data capture device may also be communicatively coupled to the legacy system if desired, or optionally have no connection to the legacy system other than through the transaction file processing device.

The transaction processing device will generally be an external piece of equipment (e.g., a box, wedge, etc.) positioned above, below, or adjacent to the legacy system (i.e., independently located from the legacy system). The transaction processing device is configured to detect and receive image and/or data file information from the image or data file capture device, and then to communicate the image and/or file(s) via a communication network for further processing. In this way, the transaction processing device is capable of routing the image and/or data file information for processing in accordance with desired programs, without costly reprogramming or modification of the legacy system.

The transaction processing device may include connectors for wires and cables to couple the device to the legacy system, the image or data capture device, and the communication networks. The device may include one or more serial ports, parallel ports, IP ports, or the like. The device may be designed such that almost no changes need to be made to the legacy system to make it compatible to the additional programs of interest. For example, the device simply needs to be plugged into an existing connector on the legacy system to enable operations. In another embodiment, the device communicates wirelessly with the legacy system, the communication networks, or the like. This may occur, for example, using a wireless port or device contained in or coupled to the device and/or to the legacy system.

In alternative embodiments, the transactional processing device may be a chip or peripheral card that is incorporated into the legacy system. For example, the device may be a peripheral card adapted to be inserted into an existing slot in a legacy device. Likewise, the transaction processing device may be a chip adapted for insertion into a socket on a chip board in the legacy system. In another embodiment, the chip or peripheral card is incorporated into a printer system, which also may comprise part of the legacy system.

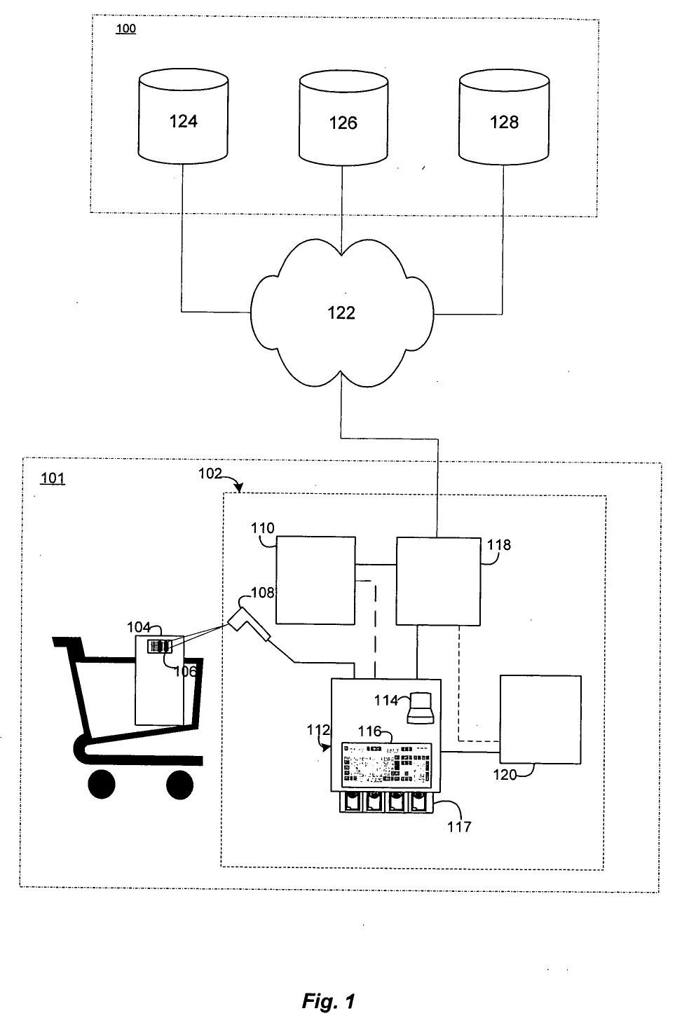

Referring now to FIG. 1, a simplified schematic depicts an embodiment of a transaction processing system 102 of the invention located, e.g., at a merchant location 101. In one embodiment, system 102 includes a legacy point-of-sale (POS) transaction terminal 112 having a display 114, a key entry input 116, and a printer 120. Terminal 112 may also be adapted to hold currency, checks, etc. in a drawer 117.

Transaction terminal 112 may include a microprocessor or logic to process, display and print information about the transaction. The information may come from multiple sources, including key entry input 116 on terminal 112. For example, product information, such as a SKU#, serial number, inventory number, etc., may be typed into the transaction terminal 112 through input 116.

Information may also be generated by a product data input terminal, such as a scanner 108, which reads product information encapsulated in a bar code label 106 attached to a product 104. Product data input terminals may also include radio frequency identification (RFID) chip readers, and other product label scanning devices (not shown).

System 102 further includes an image or data capture device 110 capable of capturing image or data file information concerning a transaction between, e.g., a customer and a merchant. In certain embodiments, image or data capture device 110 is an external device, separate from legacy POS terminal 112 (shown), and in other embodiments, image or data capture device 110 is integrally located with legacy POS terminal 112 as a component of terminal 112 (not shown). Image or data file capture device 110 may be communicatively coupled directly to legacy POS terminal 112 (dashed line), or alternatively may be communicatively coupled directly to transaction file processing device 118 (solid line), or both.

By way of example, image or data capture device 110 may be adapted to capture an image or data file through, e.g., reading tender information from a customer's magnetic stripe payment card (e.g., credit card, debit card, bank card, automatic teller machine card, stored-value card, etc.), loyalty program card information, discount card, and/or rewards program card information, driver's license information, check instrument magnetic ink character recognition (MICR) information, etc. Image or data capture device 110 may also capture image files of, e.g., check instruments, credit card sales receipts, debit card sales receipts, stored-value card sales receipts, driver's license information, etc. Image or data capture device 110 may also be configured to capture data via PIN pads, Bar Code readers, biometric readers, RFID chip readers, etc. Such data capture devices may be integral elements of the image or data capture device 110, or may be external elements of the POS system which interface with image or data capture device 10.

Image or data capture device 110 may include software which acts to operate the imaging device 110 (and perhaps also other devices shown in FIG. 1) so as to generate an image in any appropriate image format, such as a raster image format, a meta/vector image format, a graphic interchange format (“GIF”), or a joint photographic experts group (“JPEG”) format, among others. In some embodiments, the content of the image is additionally encrypted by the software for security purposes. In some embodiments, the additional elements of the system 102 or device 110 may be used to extract information that may be included with the image or data file generate by device 110. For example, MICR line information, driver's license information, etc. may be captured and coupled with an image of a check instrument.

In certain embodiments, the image or data file capture device 110 is adapted to capture image file information. In other embodiments, the image or data file capture device 110 is adapted to capture image file information in conjunction with other transaction data file information. For instance, device 110 may be adapted to capture image files of financial instruments, such as check instruments, credit card sales receipt, debit card sales receipt, stored-value card sales receipts, etc., in connection with MICR line information, payment details, customer details, customer rewards programs, customer loyalty programs, price discount programs, credit card account information, debit card account information, stored-value card information, driver's license information, etc.

Image or data capture device 110 may also receive information from contactless payment instruments presented by the customer (e.g., RFID chips). The information received from the customer RFID card may include account information, loyalty and/or payment information. Additional details on contactless transaction instruments can be found in U.S. patent application Ser. No. 11/005,864, filed Dec. 6, 2004, by Brian Kean et. al., entitled Punchout Contactless Transaction Card, the complete disclosure of which is incorporated herein by reference for all purposes.

In accordance with the present invention, the transaction system 102 further includes transaction file processing device 118, which facilitates communication between the legacy POS terminal 112 and at least one transaction file storage database 124, 126, 128 via a communication network 122. Communications network 122 may comprise elements, e.g., of the local area network (not shown) of the merchant location 101 and a public communications network, e.g., the Internet. Alternatively, in certain embodiments, communications network 122 may comprise data lines between merchant location 101 and, e.g., external service provider location 100 where database 124, 126, 128 may be located.

Device 118 is adapted to receive image data file(s), rewards data file(s), transaction data file(s), etc., from image or data capture device 110, and then to forward the image or data file(s) to at least one transaction file storage database 124, 126, 128. If desired, device 118 may translate the data received into a pre-determined file format prior to communication to database 124, 126, 128. The image and data file information communicated to transaction file storage database(s) 124, 126, 128 may then be utilized for any suitable purposes known in the art, including but not limited to, transaction authorization and warranties, Check 21, electronic check conversion, image archiving, reward program activities, loyalty program activities, etc. In certain embodiments, database 124, 126, 128 may be located at an external service provider location 100. The external service provider may then use the image and/or data file information in database 124, 126, 128 to perform functions, e.g., transaction authorization and warranties, Check 21, electronic check conversion, image archiving, reward program activities, loyalty program activities.

Those skilled in the art will appreciate that although, for purposes of clarity, databases 124, 126, 128 are illustrated separately on FIG. 1, other embodiments of the invention might incorporate all of the stored data within a single database and/or organize data structures differently than as illustrated herein.

In embodiments utilizing the information bus model discussed herein, the information discussed with respect to databases 124, 126, 128 may be pushed and/or pulled from the bus, allowing for data acquisition from a wide variety of sources. The term “database,” therefore, should be interpreted to mean a collection of information rather than read as a limitation to a particular physical or logical structure or organization. Those skilled in the art will recognize that there are a variety of ways in which transaction file processing device 118 might interface with database 124, 126, 128. Various standardized (e.g., OOBC, SQL, XML, etc.) and/or proprietary data access methodologies known in the art may be used to communicate with and access databases 124, 126, 128. Further, data may either be pushed from a database or “pulled” by device 118.

Alternatively, databases 124, 126, 128 and/or device 118 can engage in a practice known in the art as “push-pull” data warehousing, whereby information can be shared with and/or pulled from another source. Such data warehousing can be done within an enterprise or between multiple enterprises and can be performed using any of a variety of methods known to those skilled in the art including, merely by way of example, XML data transfers. In these and other ways, embodiments of the present invention, as discussed above, can interface with an information bus operation on an intra-company or inter-company basis, and can both pull information from that bus and push information to the information bus. Thus, systems in accordance with embodiments of the invention can easily integrate with other data management systems in the provider's network, for example by utilizing the information bus methodology described briefly herein and known to those skilled in the art.

Transaction file processing device 118 may also facilitate the communication of a transaction authorization between one or more financial networks (not shown) and components of system 102. To do so, device 118 may have a processor coupled to a memory. The memory maintains appropriate software or logic for the operation of device 118, including the operation of device 118 during one or more financial transactions. For example, the software or logic in device 118 may operate to select the appropriate financial network with which to communicate. In certain embodiments, the POS terminal 112 or other components of system 102 may also communicate with one or more financial networks (not shown).

Transaction file processing device 118 may assist in the processing of transaction across multiple financial networks. For instance, device 118 may communicate with a first financial processing network through a private, dedicated wide-area network, and may communicate with a second financial processing network through a public communication network. The connection between device 118 and first financial processing network may be established with a private network connection over a standard telephone line, or a dedicated connection, such as a T1 line. The connection between device 118 and second financial processing network may be established through an Internet connection, such as a dialup telephone connection, cable modem connection, DSL connection, T1 line, etc. Device 118 may also communicate with additional financial processing networks as desired.

In one aspect, using a connection via communication network(s), e.g., the Internet and/or a dedicated line, transaction file processing device 118 acts as a communication device between the legacy POS terminal 112, the image or data file capture device 110, and one or more databases 124, 126, 128. In another aspect, transaction file processing device 118 acts as a two-way communication device between the legacy POS terminal 112, the image or data file capture device 110 and one or more financial transaction networks. Device 118 operates to route data directly to the database(s) and/or financial transaction network(s) independently of the legacy POS terminal 112, thereby avoiding any costly retrofitting or reprogramming of the legacy system.

The financial networks optionally in communication with transaction file processing device 118 may include one or more servers (not shown) that receive and process commands from device 118. The servers may be coupled to databases 124, 126, 128 storing information forwarded by device 118. The information stored in the databases may include a transaction image and data file information to be used in connection with electronic check conversion transactions, Check 21, check warranty authorizations, etc, as generally known in the art.

As described above, transaction file processing device 118 may generally be independently located from the legacy POS terminal 112 and the image or data file capture device 110. In another embodiment, it may be a peripheral card inserted into a periphery slot of the legacy POS terminal 112. In certain embodiments, the transaction file processing device 118 is adapted to receive image file information from the image or data file capture device 110. In other embodiments, the transaction file processing device 118 is adapted to receive image file information in conjunction with other transaction data file information from the image or data capture device 110, as described above. For instance, device 118 may be adapted to receive image files of financial instruments, such as check instruments, credit card sales receipt, debit card sales receipt, stored-value card sales receipts, etc., in connection with MICR line information, payment details, customer details, customer rewards programs, customer loyalty programs, price discount programs, credit card account information, debit card account information, stored-value card information, driver's license information, etc.

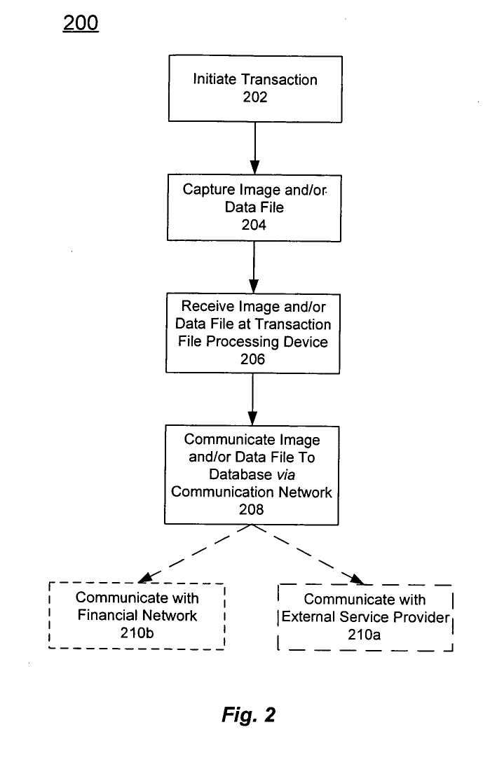

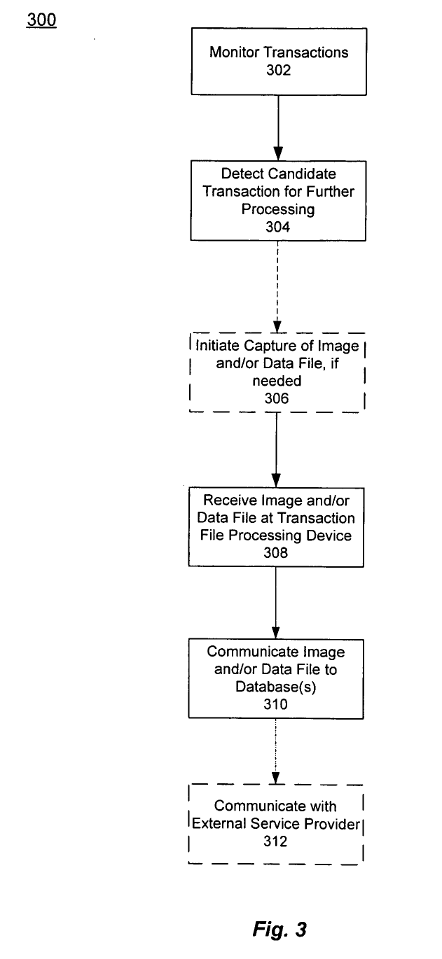

In another aspect of the invention, methods for processing at least one image or data file associated with a transaction between a first party, e.g., a merchant and a second party, e.g., a customer, are provided. The transaction may involve the exchange of payment, data, information, value, etc. As mentioned above, the methods generally involve the use of a transaction file processing device in communication with one or more transaction file storage databases. With reference to system 102 described above, an image or data file associated with a transaction originating as a legacy POS terminal 112 is generally received from an image or data file capture device 110 at a transaction file processing device 118, and communicated to at least one transaction file storage database 124, 126, 128 via a communication network 122. The transaction file processing device 118 generally allows for communication and processing of transactions without the need for retrofitting or reprogramming of legacy POS terminal 112. Certain embodiments will be discussed in more detail below with reference to FIGS. 2 and 3.

Turning now to FIG. 2, a method 200 is illustrated for processing at least one image or data file associated with a transaction between, e.g., a merchant and a customer. Although for ease of description, method 200 will be described by reference to system 102, those skilled in the art will understand that methods in accordance with various embodiments of the invention are not limited to any particular hardware or physical structure(s). In accordance with exemplary method 200, the method generally involves at block 202, initiating a transaction between, e.g., a merchant and a customer at a point-of-sale transaction terminal 112 located, e.g., at a merchant location 101. The merchant location 101 will generally include a point-of-sale transaction terminal 112, an image or data file capture device 110, and a transaction file processing device 118, as described above. In certain embodiments, the customer and the merchant will be at the same location, i.e., the merchant location 101. In other embodiments, the customer may be remote from the merchant location 101, and the merchant may initiate the transaction at a location remote from the customer, e.g., the merchant location 101.

Once the transaction is initiated, image or data file capture device 110 captures an image and/or data file associated with the transaction. In certain embodiments, the image and/or data file may comprise information concerning payment details, customer details, customer rewards programs, customer loyalty programs, or price discount programs. More particularly, the image and/or data file may comprise an image file, alone or in combination with other data file information. In one embodiment, the image file may comprise an image of a financial instrument. Exemplary financial instruments include checks, credit cards sales receipts, debit card sales receipts, stored-value card sales receipts, etc. Alternatively, the image and/or data file may comprise magnetic ink character recognition (MICR) line information, credit card account information, debit card account information, stored-value card information, driver's license information, reward program information, loyalty program information, discount program information, etc., alone or in combination.

Continuing to block 206, the image and/or data file related to the transaction from the image or data file capture device 110 is received at the transaction file processing device 118. The received image and/or data file is then communicated to at least one transaction file storage database 124, 126, 128 by transaction file processing device 118 via communication network 122 at block 208. In certain embodiments, transaction file storage database 124, 126, 128 may be located at an external service provider location, and the image and/or data file information may be further processed off-site from the merchant location 101, e.g., to obtain merchant financial warranty services, electronic check conversion services, rewards program services, loyalty program services, etc. As such, method 200 may continue at optional block 210a, wherein transaction file processing device 118 communicates with one or more external service providers to obtain transaction authorization, warranty, reward, loyalty, etc. information from (e.g., using the image and/or data file information stored in database 124, 126, 128) via communication network 122.

Method 200 may also include optional block 210b, wherein transaction file processing device 118 communicates with one or more financial networks to facilitate the transaction with the customer and the merchant. In certain embodiments, transaction file processing device 118 may communicate with a financial network to obtain authorization for a transaction from a financial network, e.g., Check 21, credit card authorizations, debit card authorizations, automatic teller card authorizations, etc. In alternative embodiments, not shown, the POS terminal 112 or other components of system 102 may communicate with one or more financial networks.

As discussed above, the transaction file processing device 118 of the invention allows for the integration of additional transactional processing capabilities to existing point-of-sale transaction terminals without the need for expensive reprogramming or retrofitting of the legacy system. In accordance with the invention, the transaction file processing device is configured as a stand-alone, add-on device to an existing legacy system which is adapted to bring new, value-added functionality to the legacy system. The transaction file processing device may be configured to provide the logic, programming, and communication interface necessary to implement to desired functionality. As such, the existing legacy system does not need to be reconfigured to implement the added functionality incorporated by way of the transaction file processing device.

In certain embodiments, additional image and/or data capture functionality may need to be added to the legacy system to fully implement the desired functionality, as discussed above. In such instances, an image and/or data capture device may also need to be interfaced with the existing system. In other embodiments, the existing legacy system will already include the necessary image and/or data capture equipment. In such instances, the transaction file processing device provides the logic, programming, and communication interface necessary to implement the additional desired functionality, while the existing legacy system provides the hardware to capture the required image and/or data file information when prompted.

By way of example, with reference to FIG. 3, in certain embodiments, the transaction processing device 118 may be configured to monitor transactions initiated at the legacy system 102 at block 302. During monitoring of the transactions, the transaction processing device 118 may be configured to detect candidate transactions for further processing at block 304 (e.g., check transactions, credit/debit/stored-value card transactions, reward/loyalty card transactions, etc.). When a candidate transaction is detected; the transaction processing device 118 may then optionally prompt for further action, at block 306, to initiate capture of the desired image and/or data files associated with the transaction, if needed. Method 300 then continues to block 308, wherein transaction file processing device receives the desired image and/or data file information from the image or data file capture device and communicates the image and/or date file information to database 124, 126, 128 via communications network 122 at block 310. At block 312, the transaction file processing device 118 may then optionally communicate with an external service provider 100 via communications network 122 to initiate a variety of service provider functionalities if desired, as described above.

In certain embodiments, at blocks 306 and 308, the transaction file processing device may communicate with the image or data capture device to prompt the image or data capture device to capture desired image and/or data file information related to the transaction and then transmit the image and/or data file information to the transaction file processing device. In other embodiments, transaction file processing device 118 intercepts image and/or data file information already captured and in-process in the legacy system 102 processes. For instance, during monitoring and detecting of candidate transaction at blocks 302 and 304, transaction file processing device 118 may be configured to detect predetermined image and/or data file information, and intercept (i.e., receive) the desired image and/or data file information from the image or data file capture device as it is processed by the legacy system 102.

The invention has now been described in detail. However, it will be appreciated that the invention may be carried out in ways other than those illustrated in the aforesaid discussion, and that certain changes and modifications may be practiced within the scope of the appended claims. Accordingly, the scope of this invention is not intended to be limited by those specific examples, but rather is to be accorded the scope represented in the following claims.

What is claimed is:

1. A system for processing at least one image and/or data file related to a transaction between a first party and a second party, the system comprising:
a point-of-sale transaction terminal;
an image or data file capture device adapted to capture an image and/or data file related to said transaction between the first party and the second party; and
a transaction file processing device in communication with at least one transaction file storage database via a communication network;
wherein said transaction file processing device is independently located from said point-of-sale transaction terminal and said image or data file capture device; and
wherein said transaction file processing device is in communication with said image or data file capture device and is configured to receive said image and/or data file from said image or data file capture device and to communicate said image and/or data file to said at least one transaction file storage database via said communication network.

2. The system of claim 1, wherein said image or data file capture device is integrally located with said point-of-sale transaction terminal.

3. The system of claim 1, wherein said image or data capture device is adapted to capture an image and/or data file that comprises information concerning payment details, customer details, customer rewards programs, customer loyalty programs, or price discount programs.

4. The system of claim 1, wherein said image or data capture device is adapted to capture an image and/or data file that comprises an image associated with said transaction.

5. The system of claim 4, wherein said image or data capture device is adapted to capture the image of a financial instrument.

6. The system of claim 5, wherein said financial instrument comprises a check, credit card sales receipt, debit card sales receipt, or stored-value card sales receipt.

7. The system of claim 1, wherein said image or data file capture device is adapted for reading check magnetic ink character recognition (MICR) line information, credit card account information, debit card account information, stored-value card information and/or driver's license information.

8. The system of claim 1, wherein said system further comprises a printer.

9. The system of claim 1, wherein said transaction file processing device is further adapted to communicate with one or more financial networks.

10. A method for processing at least one image or data file associated with a transaction between a merchant and a customer, the method comprising:
providing a transaction file processing device in communication with at least one transaction file storage database via a communication network;
initiating a transaction between a merchant and a customer at a point-of-sale transaction terminal located at a merchant location;
capturing an image and/or data file related to said transaction at an image or data file capture device;
receiving said image and/or data file at the transaction file processing device from said image or data file capture device; and
using said transaction file processing device to communicate said image or data file to said at least one transaction file storage database via said communication network;
wherein said transaction file processing device is independently located from said point-of-sale transaction terminal and said image or data file capture device.

11. The method of claim 10, wherein said image and/or data file comprises information concerning payment details, customer details, customer rewards programs, customer loyalty programs, or price discount programs.

12. The method of claim 10, wherein said image and/or data file comprises an image associated with said transaction between the merchant and the customer.

13. The method of claim 10, wherein said image and/or data file comprises an image of a financial instrument.

14. The method of claim 13, wherein said financial instrument comprises a check, credit card sales receipt, debit card sales receipt, or stored-value card sales receipt.

15. The method of claim 10, wherein said capturing an image and/or data file comprises capturing an image of a financial instrument, and reading check magnetic ink character recognition (MICR) line information, credit card account information, debit card account information, stored-value card information and/or driver's license information.

16. The method of claim 10, wherein said method further comprises communicating with one or more financial networks via said transaction file processing device.

17. A method for adding transactional processing capabilities to an existing point-of-sale transaction station at a merchant location, said method comprising:
providing an image or data file capture device adapted to capture at least one image and/or data file associated with a transaction between said merchant and a customer;
providing a transaction file processing device in communication with at least one transaction file storage database via a communication network;
wherein said transaction file processing device is communicatively coupled to and independently located from said existing point-of-sale transaction station and said image or data file capture device; and
wherein said transaction file processing device is adapted to receive an image and/or data file from said image or data file capture device and to communicate said image or data file to said at least one transaction file storage database via said communication network without the need to reconfigure said existing point-of-sale transaction station.

18. The method of claim 17, wherein said point-of sale transaction station comprises said image or data file capture device.

19. The method of claim 17, wherein said image or data capture device is adapted to capture an image and/or data file that comprises information concerning payment details, customer details, customer rewards programs, customer loyalty programs, or price discount programs.

20. The method of claim 17, wherein said transaction file processing device is further adapted to communicate with one or more financial networks.
